(19) United States
(12) Patent Application Publication
(10) Pub. No.: US 2009/0133285 A1
(43) Pub. Date: May 28, 2009

(54) Household Appliances for Washing and/or Drying Clothes

(76) Inventors: Elisabetta Bari, Portogruaro (IT); Rica Pantermehl, Cordenons (IT); Nicola Reid, Pordenone (IT)

Correspondence Address: WENDEROTH, LIND & PONACK, L.L.P., 1030 15th Street, N.W.,, Suite 400 East, Washington, DC, 20005-1503, US

(21) Appl. No.: 11/887,730

(22) PCT Filed: Mar. 13, 2006
(86) PCT No.: PCT/EP2006/060665

§ 371 Date: Jan. 30, 2008

(30) Foreign Application Priority Data
Apr. 4, 2005 (EP) 05102644 1

(51) Int. Cl. H05B 3/34; F26B 9/00; F26B 3/34; H05B 3/28

(52) U.S. Cl. 34/519; 34/619; 219/544; 219/528

(57) ABSTRACT

Household appliance for washing and/or drying clothes comprising an outer casing (2) provided with a worktop (3) and a front panel (4) carrying operational input controls (5), an opening for loading and unloading clothes, a door (6) for closing the opening, a rotational drum supported inside the casing (2). The worktop (3) comprises heating means to dry garments disposed on the worktop (3).

The present invention refers to household appliances for washing and/or drying clothes.

It is a largely known fact that garments made of delicate textiles such as cashmere are not adapted to be dried in tumble dryers due to mechanical impact on the textile fibers, which normally occur in dryers.

In order to care for delicate textiles they need to be dried by means of more gentle treatment, such as line-drying or flat-drying, which are rather time consuming processes.

The aim of the present invention is therefore to provide a household appliance for gently drying clothes eliminating the drawbacks of the cited known prior art.

An object of this invention is to provide a new drying solution for household appliances which is relatively simple in construction, trouble-free in operation, dependable, flexible in use and relatively inexpensive to manufacture, operate, service and maintain.

According to the present invention, this object is reached in a household appliance having the characteristics as recited and defined in the appended claims.

Anyway, features and advantages of the present invention may be more readily understood from the description that is given below by way of a non-limiting example with reference to the accompanying drawings, in which:

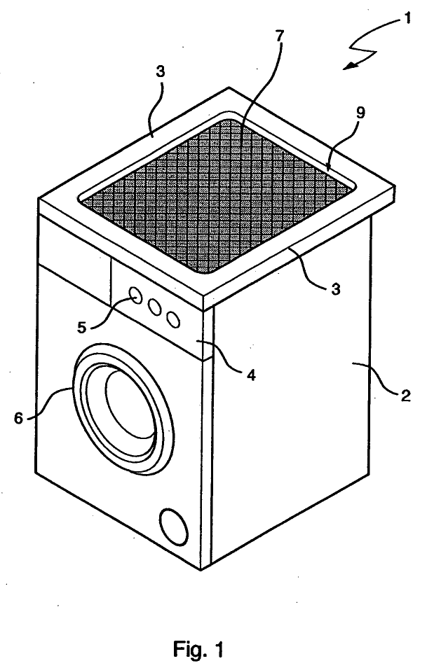

FIG. 1 is a perspective view of a household appliance according to the present invention;

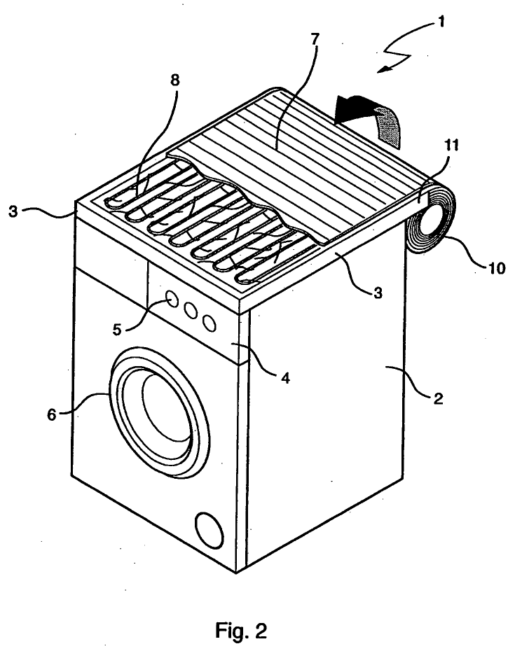

FIG. 2 is a perspective view of a household appliance according to a further embodiment of the present invention;

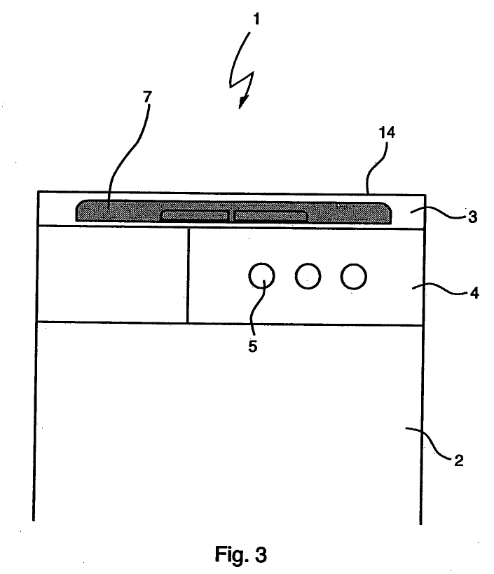

FIG. 3 is a front view of a household appliance according to a further embodiment of the present invention;

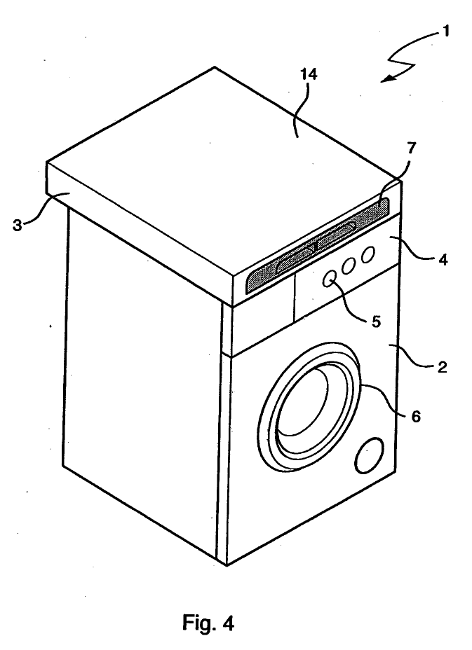

FIG. 4 is a perspective view of the household appliance of FIG. 3;

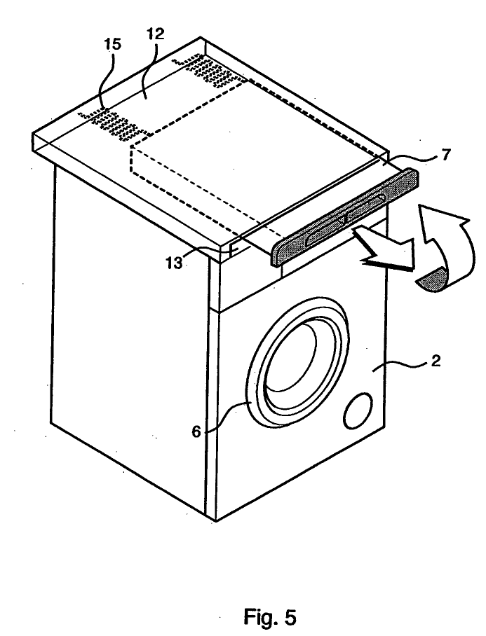

FIG. 5 is a sectional perspective view of the household appliance of FIG. 3, showing the heating mat;

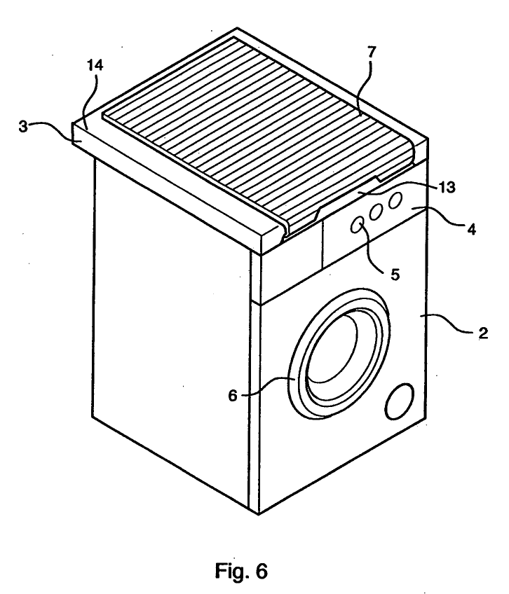

FIG. 6 is a perspective view of the household appliance of FIG. 3, showing the heating mat positioned on;

The household appliance for washing and/or drying clothes, according to the present invention, generally designated by the reference numerical 1, comprises an outer casing 2 with a worktop 3 and a front panel 4 carrying operational input controls 5, a drum rotatably supported inside said casing 2 and adapted to be loaded with items to be washed and/or dried, an opening for loading and unloading said items, a door 6 for closing the opening.

The worktop 3 comprises heating means to dry clothes disposed on the worktop 3.

Such heating means comprise at least a heating layer associated to said worktop 3 and adapted to dry a garment in response to an applied electric current, the heating layer being connected to electric power terminals provided in correspondence to the worktop 3 and it being arranged on the worktop 3 to support garments in a flat position.

Control means are provided on the front panel 4 of the household appliance in order to energize the heating layer and select different drying mode of the heating layer. It is to be noted that different drying temperature and different drying time can be required depending on the particular type of the garment textile.

Conductive polymers can be envisaged to embody the heating layer.

Advantageously said heating layer is provided in the form of a heating mat 7 comprising an electric conductor embedded in insulating material in order to provide an even heat distribution and a low surface temperature. The heating mat 7 preferably includes a flexible resistor 8 disposed in an elastomeric material such as silicone rubber, neoprene or polyamide.

Clearly other type of polymeric material or natural rubber can be used for this purpose.

In a first embodiment of the present invention a central recess or seat 9 is provided on the worktop 3 in order to support the heating mat 7 in an operative position in which the heating mat 7 preferably lies flush with a peripheral portion worktop.

In a second embodiment the household appliance comprises coiling means 10 preferably arranged in correspondence to an upper backward portion of the casing 2. The coiling means 10 can be integrally formed in an outer edge 11 of the worktop 3. The heating mat 7 is removably associated to the coiling means 10 so as to be adapted to slide, due to the resilient properties thereof, between a first position in which the heating mat 7 is wound around the coiling means 10 and a second position in which the heating mat 7 lies flat on the worktop 3.

In a further embodiment the worktop comprises a housing 12 adapted to contain the heating mat 7 when the latter is not in use, the housing having an opening 13 through which the heating mat 7 is accessible by a user. The heating mat 7 is slidably associated to the worktop 3 in order to be drawn out from the housing 12 and arranged on a top portion 14 of the worktop 3. Expediently the heating mat 7 comprises sliding hinge adapted to engage guiding means provided in the housing 12 of the worktop 3 so that the heating mat 7 can be pulled out from the housing 12 and rotated to be positioned on the top portion 14 of the worktop 3.

The resistor 8 of the heating mat 7 can be connected to extensible power supply cable 15 provided in the housing 12 or the sliding means can be provided integrally with electric power terminals adapted to energize the heating mat 7.

Clearly the heating means can be applied also to a top-loading household appliance.

Conclusively, it can therefore be stated that according to the present invention delicate textile can be dried in a gentle and effective way without large effort and without high energy consumption, thereby doing away with the serious drawback shared by prior-art machines.

1. Household appliance for washing and/or drying clothes comprising an outer casing (2) provided with a worktop (3) and a front panel (4) carrying operational input controls (5), an opening for loading and unloading clothes, a door (6) for closing the opening, a rotational drum supported inside said casing (2), characterized in that said worktop (3) comprises heating means to dry garments disposed on the worktop (3).

2. Household appliance according to claim 1, characterized in that said heating means comprise at least a heating layer to dry garments in response to an applied electric current, the heating layer being associated on the worktop (3) to support garments in a flat position.

3. Household appliance according to claim 2 characterized in that said heating layer is provided in the form of a heating mat (7) comprising one or more electric conductors embedded in insulating material.

4. Household appliance according to claim 3, characterized in that a seat (9) is provided on a top surface (14) of the worktop (3) in order to support the heating mat (7) in an operative flat position.

5. Household appliance according to claim 3, characterized in that said heating mat (7) is removably associated to coiling means (10) so as to be adapted to slide between a first position in which the heating mat (7) is wound around the coiling means (10) and a second position in which the heating mat (7) lies flat on the worktop (3).

6. Household appliance according to claim 3, characterized in that said worktop comprises an housing (12) adapted to contain the heating mat (7) when the latter is not in use, the heating mat (7) being slidably associated to the worktop (3) in order to be drawn out from the housing (12) and arranged on a top portion (14) of the worktop (3).

7. Household appliance according to claim 1 characterized in that said the heating means (7) are connected to electric power terminals provided in correspondence to the worktop (3).

8. Household appliance according to claim 1 characterized in that said heating means (7) are flexible.

9. Household appliance according to claim 1 characterized in that control means are provided on the front panel (4) of the household appliance in order to energize the heating means and select different drying mode of the heating means.

10. Method for drying garments characterized in that:
arranging a heating mat on a worktop of a household appliance,
disposing a garment onto said heating mat,
energizing said heating mat.

11. Use of a heating mat to dry garment on a worktop of household appliances.

12. Household appliance according to claim 2 characterized in that said the heating means (7) are connected to electric power terminals provided in correspondence to the worktop (3).

13. Household appliance according to claim 3 characterized in that said the heating means (7) are connected to electric power terminals provided in correspondence to the worktop (3).

14. Household appliance according to claim 4 characterized in that said the heating means (7) are connected to electric power terminals provided in correspondence to the worktop (3).

15. Household appliance according to claim 5 characterized in that said the heating means (7) are connected to electric power terminals provided in correspondence to the worktop (3).

16. Household appliance according to claim 6 characterized in that said the heating means (7) are connected to electric power terminals provided in correspondence to the worktop (3).

17. Household appliance according to claim 2 characterized in that said heating means (7) are flexible.

18. Household appliance according to claim 3 characterized in that said heating means (7) are flexible.

19. Household appliance according to claim 4 characterized in that said heating means (7) are flexible.

20. Household appliance according to claim 5 characterized in that said heating means (7) are flexible.
